(19) United States
(12) Patent Application Publication
(10) Pub. No.: US 2003/0088761 A1
(43) Pub. Date: May 8, 2003

(54) Register context usage indicator

(76) Inventor: Nigel C. Paver, Austin, TX (US)

Correspondence Address: Timothy N. Trop, TROP, PRUNER & HU, P.C., STE 100, 8554 KATY FWY, HOUSTON, TX, 77024-1805, US

(21) Appl. No.: 10/001,719

(22) Filed: Nov. 2, 2001

(51) Int. Cl. G06F 9/00

(52) U.S. Cl. 712/228

(57) ABSTRACT

A bit may be associated with the register to indicate whether or not the register has been updated. If the register has been updated, on the next context change, the contents of the register may be stored back to a memory. If no update has occurred, as determined by the update bit, then the unnecessary operation of saving the same file back to memory may be avoided, improving performance and saving power in some embodiments.

### BACKGROUND

This invention relates generally to registers that work with memories in processor-based systems.

Registers may be utilized to store information temporarily during the operation of a processor. Information may be temporarily stored in the register and ultimately stored on a memory. Conversely, the memory may provide information to the register for operations by the processor. This creates the possibility that the status of a certain piece of information may be different in the register and the memory.

As a result, errors may occur because of the lack of uniformity in the data. In other words, data intended to present the same information may be changed in the course of operating a system including registers and memory. These changes may be reflected in one of the two storage locations but not the other. As a result of this inconsistency, errors may occur.

One solution to this problem is to simply store the data from the register back to the memory every time there is a context change. A context change occurs whenever the set of data being utilized is changed because the operations being implemented by the processor change.

However, these storage operations, where information is restored back onto the memory, decrease the performance of the system and increase power consumption. Increased power consumption may be particularly important in connection with portable processor-based systems that operate from battery supplies which have limited life before required recharging.

Thus, there is a need for a way to reduce the number of times that register information must be saved back to memory.

### BRIEF DESCRIPTION OF THE DRAWINGS

FIG. 1 is a schematic depiction of hardware in accordance with one embodiment of the present invention;

FIG. 2 is a flow chart in accordance with software for one embodiment of the present invention; and

FIG. 3 is a continuation of the software shown in FIG. 2.

### DETAILED DESCRIPTION

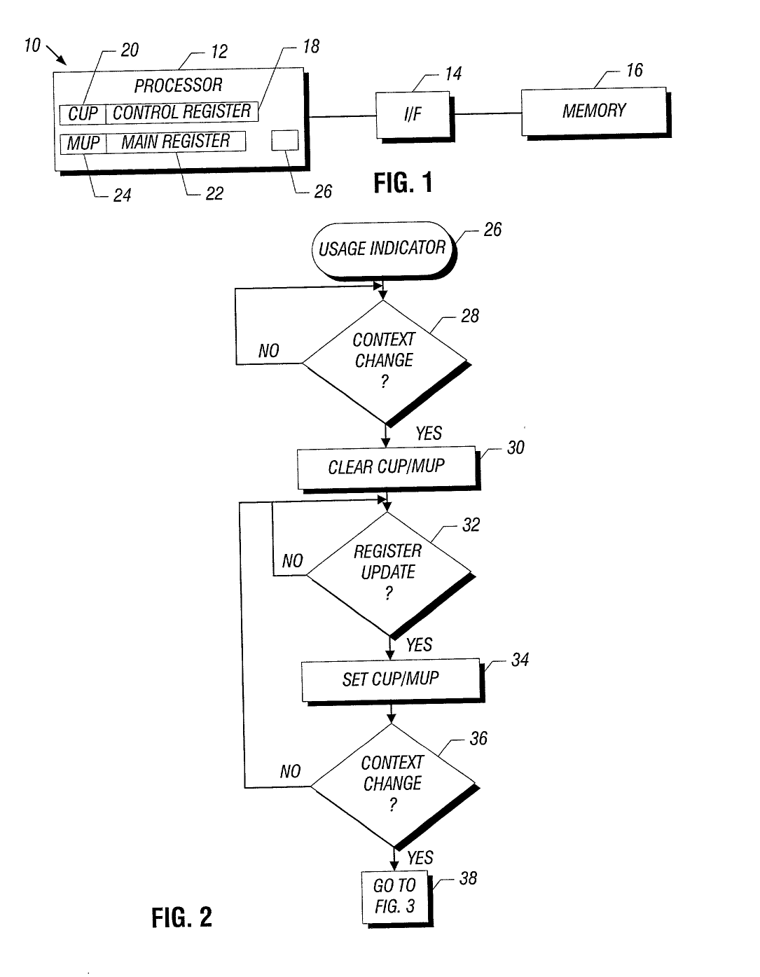

Referring to FIG. 1, a processor 12 may include one or more registers 18 and 22. In this example, one register is called the control register 18 and the other register is called the main register 22. Each register 18 or 22 has a storage associated with it that provides an indicator. Thus, the main register 22 includes a main register update (MUP) bit storage 24 and the control register 18 includes a control register update (CUP) bit storage 20.

While the storages 20 and 24 are shown as being physically associated with the registers 18 and 22, this need not be the case. For example, in some embodiments, a separate control register may be utilized to store the information stored in the storages 20 and 24.

In accordance with one embodiment of the present invention, the main register update bit may include one bit and the control register update bit may include one bit. Alternatively, a single update bit may be used to indicate whether any of a plurality of registers has been modified.

The processor 12 may be coupled to an interface 14 and ultimately to a memory 16. Data contained on the memory 16 may be read by the processor 12 and data may be stored on one or more of the registers 18 and 22. Data may ultimately be restored from a register 18 or 22 back to the memory 16 through the interface 14.

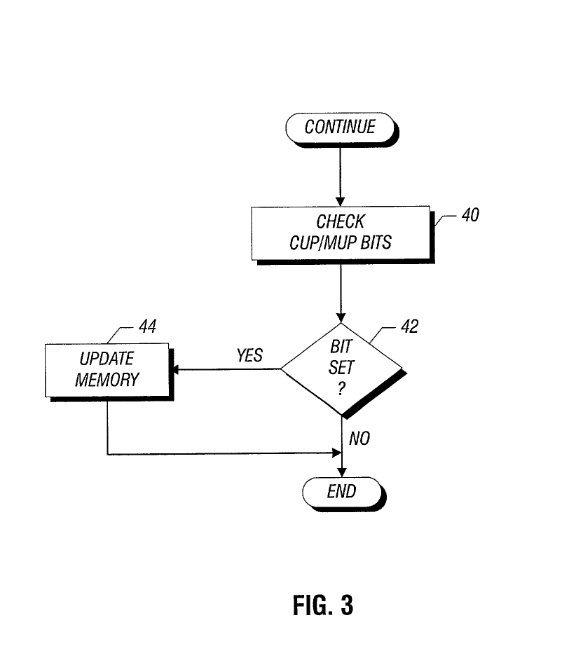

The processor 12 may include code 26, shown in FIGS. 2 and 3, which implements the MUP and CUP bits. A check at diamond 28 determines whether a context change has occurred. If so, the CUP and MUP bits stored in the storage locations 20 and 24 are cleared as indicated in block 30.

A check at diamond 32 determines whether either the control register 18 or the main register 22 has been updated. If so, the CUP and MUP bits are set in the storage 20 or 24, as appropriate, as indicated in block 34.

A check at diamond 36 determines whether a context change has occurred. If so, the CUP and MUP bits are checked, as indicated in block 40 in FIG. 3. A check at diamond 42 determines whether the bit for the register that is going through a context change is set, indicating that the register has been changed. If so, the memory 16 may be updated as indicated in block 44. In the case where a single bit indicates whether any of a plurality of registers has been changed, all of the registers may be written to memory when any of the registers has changed. This may avoid the complexity of checking whether any of a large number of registers with a small amount of data have changed.

If the bit is not set, indicating that there has been no change in the status of the data stored in the register undergoing the context change, then the memory update may be avoided. This may save power and improve the performance of the system. In particular, by avoiding unnecessary saves of the register contents back to memory 16, the performance of the system may be dramatically improved in some embodiments.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
determining whether a register has been updated; and
if the register is updated, setting an indicator bit.

2. The method of claim 1 including determining whether the register has been updated by checking an indicator bit.

3. The method of claim 2 wherein if the register has not been updated, refraining from transferring the contents of the register back to a memory.

4. The method of claim 2 including determining whether the register has been updated and if so, saving the contents of the register to memory.

5. The method of claim 4 including saving the register contents to memory on a context change.

6. The method of claim 1 including assigning a single indicator bit to a plurality of registers.

7. An article comprising a medium storing instructions that enable a processor-based system to:
determine whether a register has been updated; and
if the register is updated, set an indicator bit.

8. The article of claim 7 further storing instructions that enable the processor-based system to determine whether the register has been updated by checking an indicator bit.

9. The article of claim 8 further storing instructions that enable the processor-based system to refrain from transferring the contents of the register back to a memory if the register has not been updated.

10. The article of claim 8 further storing instructions that enable the processor-based system to determine whether the register has been updated and if so, save the contents of the register to memory.

11. The article of claim 10 further storing instructions that enable the processor-based system to save the register contents to memory on a context change.

12. The article of claim 10 further storing instructions that enable the processor-based system to save the contents of a plurality of registers to memory if an indicator bit is set.

13. A processor comprising:
a register; and
a storage storing instructions to determine whether a register has been updated and if the register is updated, set an indicator bit.

14. The processor of claim 13 wherein said storage stores instructions that enable the processor to determine whether the register has been updated by checking an indicator bit.

15. The processor of claim 14 wherein said storage stores instructions that enable the processor to refrain from transferring the contents of the register back to a memory.

16. The processor of claim 14 wherein said storage stores instructions that enable the processor to determine whether the register has been updated and if so, save the contents of the register to memory.

17. The processor of claim 16 wherein said storage stores instructions that enable the processor to save the register contents to memory on a context change.

18. The processor of claim 13 including a storage to store said bit.

19. A system comprising:
a processor;
a register coupled to said processor; and
a storage storing instructions to determine whether a register has been updated and if the register is updated, set an indicator bit.

20. The system of claim 19 including a memory and an interface between said memory and said processor.

21. The system of claim 20 wherein said storage stores instructions that enable the processor to determine whether the register has been updated by checking an indicator bit.

22. The system of claim 21 wherein said storage stores instructions that enable the processor to refrain from transferring the contents of the register back to the memory.

23. The system of claim 21 wherein said storage stores instructions that enable the processor to determine whether the register has been updated and if so, save the contents of the register to the memory.

24. The system of claim 23 wherein said storage stores instructions that enable the processor to save the register contents to memory on a context change.

25. The system of claim 19 including a storage to store said bit.

26. The system of claim 19 including a control register storing said bit and wherein said storage storing instructions and control register are part of said processor.

27. The system of claim 19 including a plurality of registers coupled to said processor and a single indicator bit for all of those registers.
